(19) United States
(12) Patent Application Publication
(10) Pub. No.: US 2017/0061455 A1
(43) Pub. Date: Mar. 2, 2017

(54) METHOD AND SYSTEM FOR SIZING OF DEMOGRAPHIC MARKETS

(71) Applicant: MasterCard International Incorporated, Purchase, NY (US)

(72) Inventors: Jeremy PASTORE, Larchmont, NY (US); Michael McNAMARA, New York, NY (US); Michael ZHAO, New York, NY (US); Weizhen HUANG, Philadelphia, PA (US)

(73) Assignee: MasterCard International Incorporated, Purchase, NY (US)

(21) Appl. No.: 15/252,606

(22) Filed: Aug. 31, 2016

Related U.S. Application Data
(60) Provisional application No. 62/212,648, filed on Sep. 1, 2015.

(51) Int. Cl. G06Q 30/02; G06F 17/30

(52) U.S. Cl. CPC G06Q 30/0203; G06F 17/30345

(57) ABSTRACT

A method for the generation of demographic market sectors includes: storing transaction data entries, each related to a payment transaction and including a geographic location and transaction amount; receiving census data from governmental agencies, the census data including data related to merchant and geographic location correspondences; receiving demographic data from third party data sources, the data including at least age, gender, income, presence of children, and geographic location data for a plurality of individuals; identifying demographic market sectors based on the census and demographic data, wherein each sector includes a subset of individuals having common age, gender, income, presence of children, and geographic location and includes at least a predetermined number of individuals; and identifying market spending for each demographic market sector based on a combination of the merchant and geographic location correspondences and a subset of the plurality of transaction data entries located in the respective demographic market sector.

### CROSS-REFERENCE TO RELATED APPLICATIONS

Priority is claimed to U.S. Provisional Patent Application No. 62/212,648, herein incorporated by reference in its entirety.

### FIELD

The present disclosure relates to the sizing of demographic markets, specifically the identification and forecasting of market spending, based on aggregated transaction data, for a plurality of demographic market sectors identified via multiple data sources.

### BACKGROUND

Commercial entities, such as merchants, retailers, manufacturers, advertisers, etc. are often interested in gathering useful data about consumers to facilitate sales. Data that may be gathered may often be useful to an entity, such as to identify new advertising campaigns, to target ideal consumers, for creating focus groups, etc. In many cases, data that involves demographics may often be favored by entities, as the data may provide insight as to the consumers that purchase goods or services, providing information that may be useful for cross-selling, advertising, etc.

Demographic data may be even more valuable when combined with other data, such as transaction data associated with a merchant, industry, geographic location, etc. Methods for combining demographic data gathered from a demographic tracking agency and transaction data are described in more detail in U.S. Patent Publication No. 2013/0024274, entitled “Method and System for Measuring Advertising Effectiveness Using Microsegments,” by Curtis Villars, U.S. Patent Publication No. 2015/0347624, entitled “Systems and methods for Linking and Analyzing Data From Disparate Data Sets,” by Curtis Villars, U.S. Patent Publication No. 2013/0024242, entitled “Protecting Privacy in Audience Creation,” by Curtis Villars, et al., U.S. Patent Publication No. 2014/0180767, entitled “Method and System for Assigning Spending Behaviors to Geographic Areas,” by Curtis Villars et al., which are herein incorporated by reference in their entirety. In some cases, such data may not be enough to provide an accurate assessment of the demographics located in a particular geographic area or for identifying the market conditions in a geographic area.

Thus, there is a need for a technological solution to gather and pair additional data to identify accurate demographic market sectors, which may be identified and sized in a manner to prevent the use of personally identifiable information, while still granular enough to be useful in the identification and forecasting of market spending.

### SUMMARY

The present disclosure provides a description of systems and methods for the generation of demographic market sectors with associated spending data. Data related to demographics and geographic locations are gathered from multiple data sources, including governmental agency data, and combined with transactional data to identify demographic market sectors that are of a suitable size with market spending identified therefore. Such data may be useful for a plurality of different products, including, in some embodiments, the forecasting of future market spending for a specific merchant industry, geographic area, and/or demographic sector.

A method for the generation of demographic market sectors with associated spending data includes: storing, in a transaction database of a processing server, a plurality of transaction data entries, wherein each transaction data entry is a structured data set related to a payment transaction including at least a geographic location, merchant identifier, transaction amount, and transaction time and/or date; receiving, by a receiving device of the processing server, census data from one or more governmental agencies, wherein the census data includes data related to at least merchant and geographic location correspondences; receiving, by the receiving device of the processing server, demographic data from one or more third party data sources, wherein the demographic data includes at least age, gender, income, presence of children, and geographic location data for a plurality of individuals; identifying, by a data identification module of the processing server, a plurality of demographic market sectors based on at least the census data and the demographic data, wherein each demographic market sector includes a subset of individuals having common age, gender, income, presence of children data, and geographic location data and includes at least a predetermined number of individuals; and identifying, by the data identification of the processing server, market spending for each of the plurality of demographic market sectors based on at least a combination of the merchant and geographic location correspondences included in the census data and a subset of the plurality of transaction data entries where the included geographic location corresponds to the common geographic location data associated with the respective demographic market sector.

A system for the generation of demographic market sectors with associated spending data includes: a transaction database of a processing server configured to store a plurality of transaction data entries, wherein each transaction data entry is a structured data set related to a payment transaction including at least a geographic location, merchant identifier, transaction amount, and transaction time and/or date; a receiving device of the processing server configured to receive census data from one or more governmental agencies, wherein the census data includes data related to at least merchant and geographic location correspondences, and demographic data from one or more third party data sources, wherein the demographic data includes at least age, gender, income, presence of children, and geographic location data for a plurality of individuals; and a data identification module of the processing server configured to identify a plurality of demographic market sectors based on at least the census data and the demographic data, wherein each demographic market sector includes a subset of individuals having common age, gender, income, presence of children data, and geographic location data and includes at least a predetermined number of individuals, and identify market spending for each of the plurality of demographic market sectors based on at least a combination of the merchant and geographic location correspondences included in the census data and a subset of the plurality of transaction data entries where the included geographic location corresponds to the common geographic location data associated with the respective demographic market sector.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the identification of demographic market sectors and market spending associated therewith in accordance with exemplary embodiments.

FIG. 2 is a block diagram illustrating the processing server of the system of FIG. 1 for the identification of demographic market sectors and associated market spending in accordance with exemplary embodiments.

FIG. 3 is a block diagram illustrating the combining of data from multiple data sources to identify demographic market sectors and associated market spending in accordance with exemplary embodiments.

FIG. 4 is a flow diagram illustrating a process for forecasting market spending for a demographic market sector in accordance with exemplary embodiments.

FIG. 5 is a flow chart illustrating an exemplary method for the generation of demographic market sectors with associated spending data in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

### System for Generation and Sizing of Demographic Market Sectors

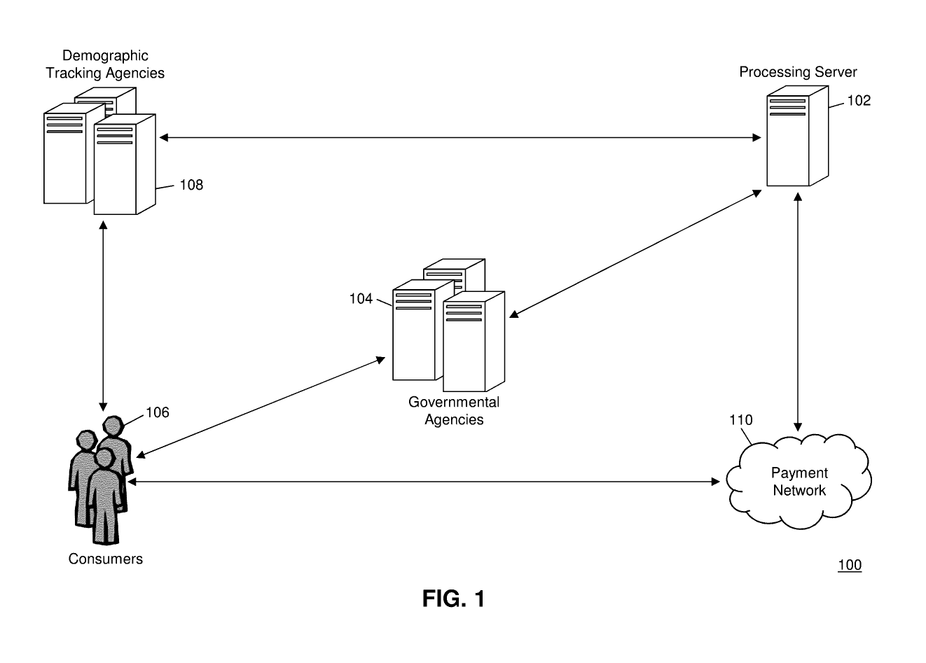

FIG. 1 illustrates a system 100 for the generation and sizing of demographic market sectors and the identification of market spending associated therewith, including the redistribution of transaction account spending and net consumption for demographic market sectors and the forecasting of future market spending thereof.

The system 100 may include a processing server 102. The processing server 102, discussed in more detail below, may be configured to generate demographic market sectors based on data received from a plurality of different data sources, where each demographic market sector may be sized by the processing server 102 to protect personally identifiable information of individuals associated therewith. The processing server 102 may, as discussed in more detail below, be configured to identify a demographic market sector based on at least census data, demographic data, and transaction data.

The census data may be received by the processing server 102 from one or more governmental agencies 104. The processing server 102 may be configured to receive the census data from the governmental agencies 104 using any suitable communication network and method, whereby the governmental agencies may electronically transmit data signals to the processing server 102 using the communication network, the data signals being superimposed or otherwise encoded with the census data. The governmental agencies 104 may include, for example, the Census Bureau, Department of Commerce, Department of Labor, Bureau of Labor and Statistics, etc. The census data may include any data associated with the governmental agencies 104 that may be provided to the processing server 102, which may include at least data related to the correspondence of merchants and geographic locations. Such data may include, for example, geographical distribution of merchants generally or of specific merchant types and/or industries, overall spending at merchants (e.g., or of specific merchant types and/or industries) by geographic location, etc. In some embodiments, the census data may also include economic market data, which may be related to market spending by merchant, geographic location, demographic characteristic, etc.

In some cases, the census data may include demographic data associated with a plurality of consumers 106. Such demographic data may include demographic characteristics gathered as part of census taking performed by the governmental agencies 104. Demographic characteristics may include gender, age, income, presence of children, occupation, education, familial status, marital status, residential status, zip code, postal code, area code, municipality, geographic location, etc. In some instances, demographic characteristics may be bucketed or otherwise obscured. For instance, age may be bucketed as a plurality of ages (e.g., 18-25, 26-33, etc.), or the values of a demographic characteristics may be replaced by a variable with the associated value unknown to the processing server 102 to protect PII, such as age buckets being represented by the letters A through F, with the corresponding age ranges unavailable to the processing server 102.

Demographic data may be received by the processing server 102 from one or more demographic tracking agencies 108. The demographic tracking agencies 108 may be configured to gather demographic data from a plurality of consumers 106 using suitable methods. The demographic tracking agencies 108 may gather a plurality of demographic characteristics for the consumers 106, which may include at least age, income, presence of children, and geographic location data for the consumers 106. In some cases, the demographic characteristics may be bucketed or otherwise obscured, as discussed above. The demographic tracking agencies 108 may electronically transmit the demographic data to the processing server 102 using a suitable communication network and method, where the demographic data may be superimposed or otherwise encoded in data signals electronically transmitted thereby.

The transaction data may be received by the processing server 102 from one or more payment networks 110, where the payment networks 110 are configured to process payment transactions using suitable methods associated therewith. The processing server 102 may receive the transaction data from the payment networks 110, which may be included in transaction messages received and/or generated by the payment network 110 as part of the processing of the payment transactions, or parsed therefrom. Transaction messages may be specially formatted data messages formatted pursuant to one or more standards governing the exchange of financial transaction messages, such as the International Organization of Standardization's ISO 8583 or 20022 standards. In some instances, the processing server 102 may be a part of the payment network 110 and may receive the transaction data via internal communication methods, such as during the processing of the related payment transactions. In other instances, the processing server 102 may receive the transaction data using a suitable communication network and method, which may include the payment rails associated with the payment network 110.

The transaction data may include data related to payment transactions that are processed by the payment network 110 and involving the plurality of consumers 106. The transaction data for each payment transaction may include at least a geographic location, merchant identifier, transaction amount, and transaction time and/or date. In some instances, the transaction data may also include one or more of: currency type, merchant name, merchant category code, issuer identifier, acquirer identifier, product data, offer data, reward data, loyalty data, merchant data, consumer data, issuer data, acquirer data, etc. The transaction data may be received by the processing server 102 and stored in a database included therein, as discussed in more detail below.

The processing server 102 may be configured to identify demographic market sectors based on at least the census data and demographic data. Each demographic market sector may be associated with a geographic area, referred to herein as a “sector,” where each demographic market sector may be associated with a subset of the plurality of consumers 106 that have a common age, gender, income, and presence of children, and other demographic characteristics, as applicable, that are associated with the related geographic area. As such, a sector may have multiple demographic market sectors associated therewith, for multiple groups of consumers 106 that are associated with the corresponding geographic area that have common demographic characteristics.

In an exemplary embodiment, the processing server 102 may be configured to size demographic market sectors such that the respective sector includes at least a predetermined number of consumers 106 such that the demographic market sectors and data associated therewith are not personally identifiable to any consumer 106. For example, the predetermined number may be 100, where the processing server 102 may size the geographic areas used as sectors such that no demographic market sector includes less than 100 consumers 106. In some instances, each demographic market sector may be generated to include the same number of consumers 106, where the size of the geographic area may vary accordingly (e.g., having a much smaller size in a dense, urban area and a much larger size in a sparse, rural area). In other instances, each demographic market sector may be generated to be the same geographic size, where the number of consumers 106 associated therewith may vary accordingly.

In some embodiments, the demographic market sectors may be further based on the transaction data. For instance, demographic market sectors may be sized based on the frequency of payment transactions in the associated geographic area as based on the geographic locations included in the transaction data, where each sector may have a geographic area such that each demographic market sector includes the same or a similar frequency of payment transactions. In other cases, demographic market sectors may be sized based on the aggregated transaction amount for payment transactions in the associated geographic area.

Once the demographic market sectors are generated and sized, the processing server 102 may identify market spending for each of the plurality of demographic market sectors based on at least the transaction data and the census data. In some instances, the processing server 102 may identify the overall market spending for a sector based on the transaction data, which may then be attributed to the different demographic market sectors associated with that sector based on the census data and/or demographic data, such as based on demographic distributions in the geographic area. For instance, the spending in a geographic area may be $100,000 a year (e.g., based on the transaction data and/or economic market data from the census data), with the geographic area having three different demographic market sectors, where the demographic and/or census data indicates that 60% of the consumers 106 in the area are in a first demographic market sector (e.g., based on common demographic characteristics). In such a case, the processing server 102 may thus attribute $60,000 a year of the geographic area's spending to that demographic market sector as its market spending. In some cases, market spending may be broken down by one or more criteria, such as merchant industry or other delineation.

In some embodiments, the processing server 102 may be configured to forecast future spending for a sector or a specific demographic market sector. In such embodiments, the processing server 102 may divide the market spending in a demographic market sector (e.g., or whole sector, as applicable) into a time series, where the time series for a demographic market sector may have the market spending for the sector divided up into each month of a year or other time period, where the time period may be based on the requested forecast (e.g., a forecast for yearly spending may use time periods of a year, while a forecast for monthly spending may use monthly time periods, etc.). The processing server 102 may identify the market spending for each of the entries in the time series for the demographic market sector and may then forecast the future market spending in the demographic market sector based thereon.

In one embodiment, the forecast may be identified using a seasonal time series model, such as the Holt-Winters model. For instance, in such an embodiment, the Holt-Winters model may have the forecasted market spending to be identified using the following equation:

Y_{T+τ}=(a_{T}+τb_{T})s_{T} (1)

In the equation (1), the market spending may be represented by Y, found for a time T in the future. The additional variables of equation (1) may be solved for by the following:

$$\begin{matrix}{a}_{t} = α \frac{{Y}_{t}}{{S}_{t - p}} + ( 1 - α ) ( {a}_{t - 1} + {b}_{t - 1} ) & ( 2 ) \\ {b}_{t} = β ( {a}_{t} - {a}_{t - 1} ) + ( 1 - β ) {b}_{t - 1} & ( 3 ) \\ {s}_{t} = γ \frac{{Y}_{t}}{{a}_{t}} + ( 1 - γ ) {s}_{t - p} & ( 4 )\end{matrix}$$

In the equations (2) through (4), the values α, β, and γ may be smoothing parameters, where aₜ is the smoothed level at time t, bₜ is the change in the trend at time t, sₜ is the seasonal smooth at time t and p is the number of seasons per year. In the above example, the number of seasons may be, for instance, twelve, for each month in the time series.

In some embodiments, the processing server 102 may be configured to perform redistributions of data associated with the demographic market sectors for use in identifying the market spending for each demographic market sector. In some instances, the processing server 102 may redistribute the transaction data. For example, the transaction data, gathered via the payment network 110, may disproportionally over-represent some demographics in a sector, such as due to the disproportionate use of payment cards and other payment instruments with which the payment network 110 is associated. In such cases, the processing server 102 may redistribute the transaction data for a given sector and demographic segment to identify redistributed spending estimates, which may be used in identifying a redistributed market spend for the associated demographic market sector.

In some such embodiments, the processing server 102 may use a systematic approach to redistribute the spending at a demographic segment level. The processing server 102 may calculate the estimated spend (e.g., as redistributed) for a given demographic market sector based on at least a combination of: overall market spend for that demographic segment across all sectors (e.g., based on census data), the number of unique demographic segments in the sector, and the originally estimated market spend for each of the demographic segment in the sector. In other such embodiments, the processing server 102 may use a systematic approach to redistribute the spending at the account level. In such cases, the processing server 102 may calculate the redistributed market spend for a specific demographic market sector based on at least a combination of: the overall market spend for that demographic segment across all sectors, the aggregated spending for accounts in that demographic segment across all sectors (e.g., determined from transaction data), which may be sampled with replacement across a predetermined number of sampling iterations, the number of unique demographic segments in the sector, and the originally estimated market spend for each of the demographic segment in the sector. The resulting market spends may be redistributions to compensate for any disproportionality of the transaction data that may be received from the payment network 110.

In some embodiments, the processing server 102 may also be configured to redistribute the market spending based on consumption of each of the demographic segments, as the transaction data may be disproportional, as discussed above. In such embodiments, the processing server 102 may use the following set of equations to calculate a percentage of consumption for a specific demographic segment, which may be applied to the demographic market sectors for identification of the market spending:

$$\begin{matrix}{C}_{j , k} = {P}_{j , k} \frac{1}{{A}_{j , k}^{u} - {A}_{j , k}^{l}} {\int }_{{A}_{j , k}^{l}}^{{A}_{j , k}^{u}} C ( A ) d A & ( 5 ) \\ {c}_{j , k} = {C}_{j , k} / {\sum }_{j , k} {C}_{j , k} & ( 6 ) \\ {C}_{i , j , k} = {P}_{i , j , k} \frac{1}{{I}_{j , k}^{u} - {I}_{j , k}^{l}} {\int }_{{I}_{j , k}^{l}}^{{I}_{j , k}^{u}} C ( I ) d I & ( 7 ) \\ {c}_{i , j , k} = {c}_{j , k} * {C}_{i , j , k} / {\sum }_{i} {C}_{i , j , k} & ( 8 ) \\ {c}_{i , j , k , l} = {c}_{i , j , k} * {P}_{l} / {\sum }_{i} {P}_{l} & ( 9 )\end{matrix}$$

In the equations (5) through (9), i, j, k, and l may be indices for income, gender, age, and presence of children, respectively; C(A) and C(I) may be consumption per person as an estimated function of age and income, respectively; A_{j,k}^{u} and A_{j,k}^{l} may be upper and lower bounds for the j^{th} gender and k^{th} age brackets; P_{i,j,k,l} may be the population of the i^{th} income bracket, j^{th} gender, k^{th} age bracket, and l^{th} presence of children; C_{i,j,k} may be the net consumption for the i^{th} income bracket, j^{th} gender, and k^{th} age bracket; and c_{i,j,k,l} may be the percentage of consumption for the i^{th} income bracket, j^{th} gender, k^{th} age bracket, and l^{th} presence of children out of all total consumptions. The consumption percentages may be used to adjust the transaction data or otherwise may be used in the identification of market spending for the demographic market sectors, based on the consumption identified for the respective demographic segments using the above equations.

The processing server 102 may be configured to make the data identified herein available to one or more external entities. For instance, the processing server 102 may be configured to electronically transmit known or forecasted market spending for demographic market sectors as requested by a third party, such as via an application program, web site, or other suitable interface. In an example, an advertiser may request forecasted market spending for several months for a plurality of demographic market sectors in a geographic area, which may be requested via a web page and the results, identified by the processing server 102 using the methods discussed herein. The advertiser may view the results on the web page, where the results may be illustrated via bar graphs, heat maps, or other suitable methods.

The methods and systems discussed herein enable the processing server 102 to accurately identify the market spending for a plurality of demographic market sectors based on a combination of data received from a plurality of different sources, including census data obtained from governmental agencies 104 and demographic data received from demographic tracking agencies 108. In some instances, the processing server 102 may also redistribute data to further increase the accuracy of market spending estimates, and may also be configured to forecast future market spending based on the identified market spending using seasonal time series.

### Processing Server

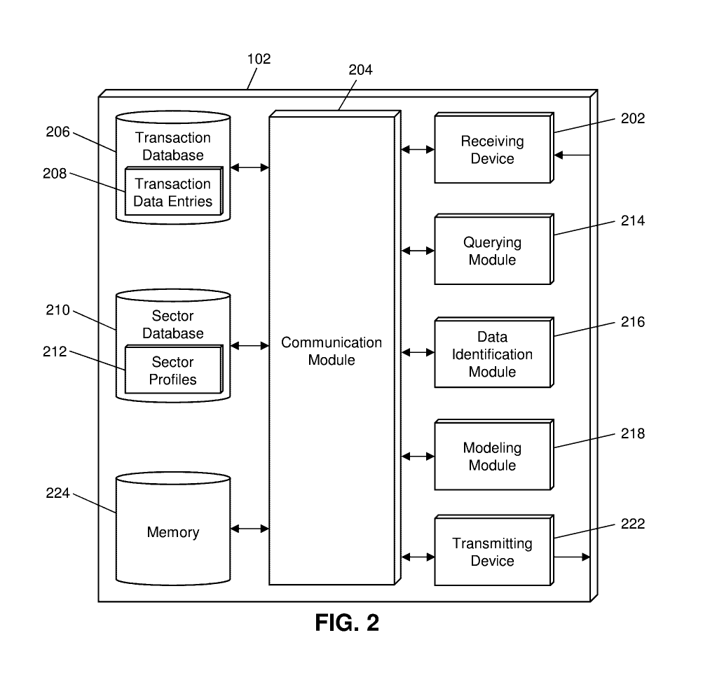

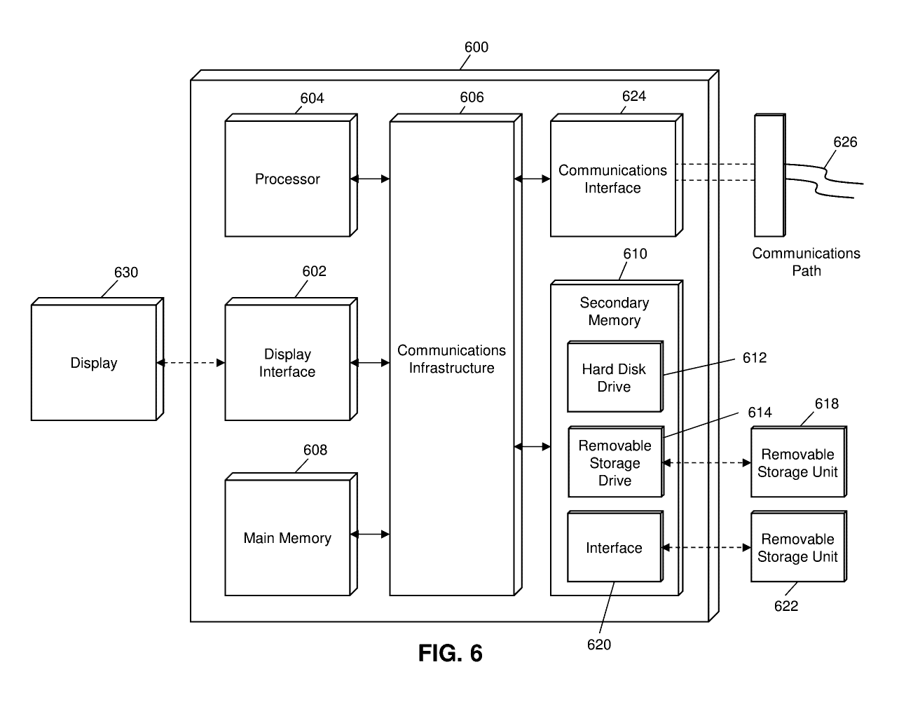

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from governmental agencies 104, demographic tracking agencies 108, payment networks 110, and other entities via one or more networks, such as the Internet, local area networks, wireless area networks, cellular communication networks, radio frequency, payment rails, etc. In some embodiments, the receiving device 202 may be comprised of multiple devices, such as different receiving devices for receiving data over different networks, such as a first receiving device for receiving data over a local area network and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by governmental agencies 104 that are superimposed or otherwise encoded with census data. The census data may include at least data related to merchant and geographic location correspondences, and may also include economic market data, including data related to correspondences between market spending and geographic location, market spending and demographic characteristics, market spending and merchant industries, etc. The receiving device 202 may also be configured to receive data signals electronically transmitted by demographic tracking agencies 108, which may be superimposed or otherwise encoded with demographic data. The demographic data may be associated with one or more individuals (e.g., consumers 106) and include at least age, gender, income, presence of children, and geographic location data for each of the individuals. In an exemplary embodiment, the demographic data may not include personally identifiable information. The receiving device 202 may also be configured to receive data signals electronically transmitted by payment networks 110, which may be superimposed or otherwise encoded with transaction data for a plurality of payment transactions, the transaction data including at least a transaction amount, transaction time and/or date, merchant identifier, and geographic location for the respective payment transaction.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, data identification module 216, modeling module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a transaction database 206. The transaction database 206 may be configured to store a plurality of transaction data entries 208 using a suitable data storage format and schema. The transaction database 206 may be a relational database that utilizes structured query language for the storage, identification, modifying, updating, accessing, etc. of structured data sets stored therein. Each transaction data entry 208 may be configured to store data related to a payment transaction, including at least a geographic location, merchant identifier, transaction amount, and transaction time and/or date for the related payment transaction. In some instances, a transaction data entry 208 may also include at least one of: currency, merchant name, merchant category code, product data, consumer data, issuer data, acquirer data, offer data, loyalty data, reward data, point of sale data, etc.

The processing server 102 may also include a sector database 210. The sector database 210 may be configured to store a plurality of sector profiles 212 using a suitable data storage format and schema. The sector database 210 may be a relational database that utilizes structured query language for the storage, identification, modifying, updating, accessing, etc. of structured data sets stored therein. Each sector profile 212 may be configured to store data related to a demographic market sector as identified by the processing server 102. The data may include, for instance, a unique identifier (e.g., primary key, index, etc.) associated with the related demographic market sector, the geographic area (e.g., sector index) of the demographic market sector, the demographic segment, market spend data, forecasted market spending, etc.

The processing server 102 may include a querying module 214. The querying module 214 may be configured to execute queries on databases to identify information. The querying module 214 may receive one or more data values or query strings, and may execute a query string based thereon on an indicated database, such as the transaction database 206, to identify information stored therein. The querying module 214 may then output the identified information to an appropriate engine or module of the processing server 102 as necessary. The querying module 214 may, for example, execute a query on the transaction database 206 to identify a plurality of transaction data entries 208 located in a specific sector (e.g., based on the included geographic location) for use in identifying the market spend for a demographic market sector, or may execute a query on the sector database 210 to insert a new sector profile 212 or update data included in an existing sector profile 212, such as following a forecast of market spend for the related demographic market sector.

The processing server 102 may also include a data identification module 216. The data identification module 216 may be configured to perform the functions of the processing server 102 discussed herein. The data identification module 216 may receive instructions, may identify data based thereon, and may output the data to another module or engine of the processing server 102. In some instances, the instructions may be accompanied by data for use in the data identification. In other instances, the data identification module 216 may be configured to identify data for use therein, such as by instructing the querying module 214 to execute queries for the identification of data. The data identification module 216 may be configured to identify demographic market sectors based on census and demographic data, and may also be configured to identify market spending for demographic market sectors based on transaction data, including dividing market spending for a demographic market sector into a time series. In some embodiments, the data identification module 216 may also be configured to identify redistributions of transaction data and consumption for demographic market sectors.

The processing server 102 may also include a modeling module 218. The modeling module 218 may be configured to model data for use in performing the functions of the processing server 102 as discussed herein. The modeling module 218 may receive instructions as input, may model data based on the instructions, and may output data obtained via the model to another module or engine of the processing server 102. The modeling module 218 may be configured to model the market spending for a demographic market sector, or sector, as applicable, to forecast future market spend for the demographic market sector.

The processing server 102 may also include a transmitting device 222. The transmitting device 222 may be configured to transmit data over one or more networks via one or more network protocols. In some instances, the transmitting device 222 may be configured to transmit data to governmental agencies 104, demographic tracking agencies 108, payment networks 110, and other entities via one or more networks, such as the Internet, local area networks, wireless area networks, cellular communication networks, radio frequency, payment rails, etc. In some embodiments, the transmitting device 222 may be comprised of multiple devices, such as different transmitting devices for transmitting data over different networks, such as a first transmitting device for transmitting data over a local area network and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to governmental agencies 104, demographic tracking agencies 108, and payment networks 110 that may be superimposed or otherwise encoded with data requests, such as to request census data, demographic data, transaction data, etc. The transmitting device 222 may also be configured to electronically transmit data signals to additional entities, such as data requestors, which may be superimposed or otherwise encoded with market spending data, including identified market spend and/or forecasted market spend for one or more demographic market sectors.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### Identification of Market Spending by Demographic Market Sectors

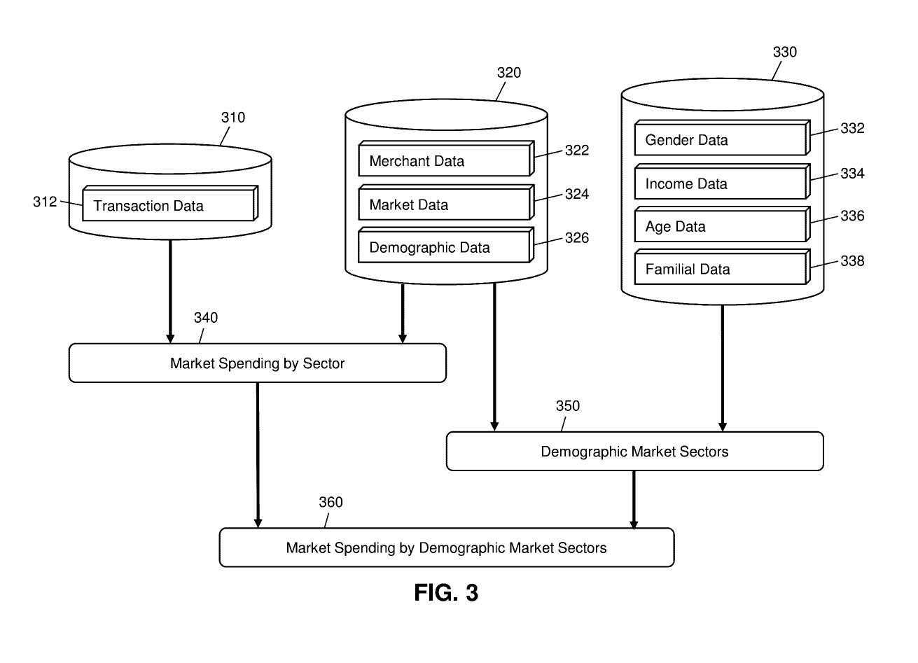

FIG. 3 illustrates the identification of demographic market sectors and market spending thereof based on a combination of transaction data, census data, and demographic data.

The receiving device 202 of the processing server 102 may receive data 310 from one or more payment networks 110. The data 310 received from the payment networks 110 may include transaction data 312 for a plurality of different payment transactions, where the transaction data 312 includes at least a transaction amount, transaction time and/or date, geographic location, and merchant identifier for each of the payment transactions. The receiving device 202 of the processing server 102 may also receive census data 320 from one or more governmental agencies 104. The census data 320 may include merchant data 322, market data 324, and demographic data 326, which may include correspondences thereof, such as correspondences between merchants and economic market spending, correspondences between demographic characteristics and economic market spending, etc.

The data identification module 216 of the processing server 102 may be configured to identify sector market spending 340, which may be market spending identified by the data identification module 216 for each of a plurality of different geographic areas as sectors. The sector market spending 340 may be identified based on the transaction data entries 312 and the geographic locations and transaction amounts included therein, as well as the merchant data 322 and market data 324 included in the census data 320.

The receiving device 202 of the processing server 102 may also receive demographic data 330 from one or more demographic tracking agencies 108. The demographic data 330 may include at least gender data 332, income data 334, age data 336, and familial data 338 for a plurality of individuals (e.g., consumers 106). In some instances, the demographic data 330 may also include geographic location data. In some cases, the data included in the demographic data 330 may be bucketed or otherwise obscured.

The data identification module 216 of the processing server 102 may be configured to identify a plurality of demographic market sectors 350. The demographic market sectors 350 may be based on the census data 320 and the demographic data 330, where each demographic market sector 350 may be associated with a geographic area as a sector and with a demographic segment, where the demographic segment may be associated with a specific age, gender, income, and family status combination. Each demographic market sector 350 may be sized such that the number of individuals included therein is of at least a predetermined number such that each demographic market sector 350 or data associated therewith is not personally identifiable to any individual. In some instances, the sectors for the demographic market sectors 350 may be the same sectors as the market spending sectors 340.

The data identification module 216 of the processing server 102 may also identify market spending 360 for each of the demographic market sectors 350 based on the demographic market sectors 350 and the market spending sectors 340. In some instances, the data identification module 216 may be configured to redistribute the market spending sector 340 data, such as discussed above, prior to the identification of the market spending 360 for the demographic market sectors 350. The market spending 360 may be such that the sum of the market spending 360 for each of the demographic market sectors 350 in a single sector may equal the corresponding market spending sector 340. In some instances, the market spending 360 may also be further based on the market data 324 included in the census data 320, such as may be adjusted based on the market data 324.

### Process for Forecasting Market Spending for Demographic Market Sectors

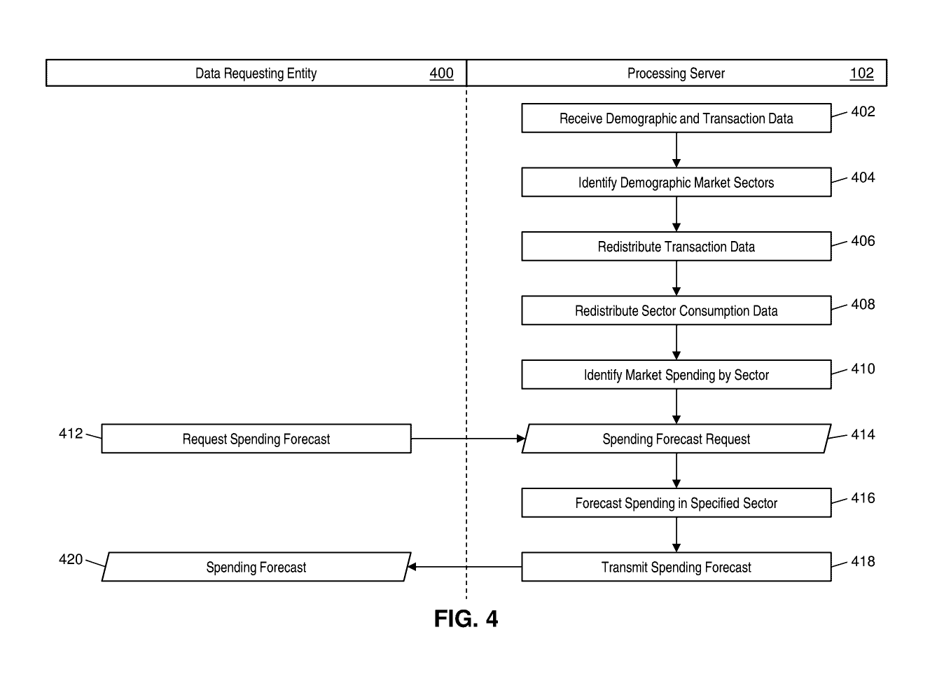

FIG. 4 illustrates a process for the forecasting of future market spending in a demographic market sector based on a time series of market spending identified for a demographic market sector based on data received from a plurality of different sources and combined using the methods discussed herein.

In step 402, the receiving device 202 of the processing server 102 may receive demographic data from demographic tracking agencies 108, census data from governmental agencies 104, and transaction data from one or more payment networks 110. The demographic data may include at least an age, gender, income, presence of children, and geographic location for a plurality of individuals. The census data may include at least merchant and geographic location correspondences. The transaction data may include at least a transaction amount, transaction time and/or date, merchant identifier, and geographic location for a plurality of payment transactions.

In step 404, the data identification module 216 of the processing server 102 may identify a plurality of demographic market sectors based on at least the census data and demographic data. Each demographic market sector may be associated with a sector (e.g., geographic area) and a demographic segment, wherein the demographic segment is a set of demographic characteristics where each individual included therein has a common set of demographic characteristics, the demographic characteristics including at least age, gender, income, and presence of children, and where each individual's associated geographic location is included in the corresponding sector.

In step 406, the data identification module 216 of the processing server 102 may redistribute the transaction data received from the payment network 110. The transaction data may be redistributed to reduce any disproportionality in the spending data associated therewith. The redistribution may be based on at least one of: the number of demographic segments, overall market spending for the sector, overall market spending for the demographic segment across all sectors, market spend for the demographic market sector prior to redistribution, etc. In step 408, the data identification module 216 may perform redistribution based on consumption data, such as discussed above, where the redistribution may be based on at least one of: the number of demographic market segments, overall market spending for the sector, number of transaction accounts, sample iterations, etc.

In step 410, the data identification module 216 of the processing server 102 may identify market spending for each demographic market sector based on the redistributed data. In step 412, a data requesting entity 400 may electronically transmit a data signal to the processing server 102 using a suitable communication network and method, where the data signal is superimposed or otherwise encoded with a spending forecast request. In step 414, the receiving device 202 of the processing server 102, may receive the spending forecast request, which may include at least a demographic market sector, and may further include a time range for which a forecast is requested.

In step 416, the modeling module 218 of the processing server 102 may forecast the requested market spending for the demographic market sector specified in the spending forecast request. In some instances, the data identification module 216 may divide the market spending for the demographic market sector into a time series prior to the forecasting, where the period for the time series may be based on the period of time for which the forecast is requested. In some embodiments, the future spending may be forecast using a seasonal time series model. In some cases, the seasonal time series model may be the Holt-Winters model. In step 418, the transmitting device 222 of the processing server 102 may electronically transmit the forecasted market spending to the data requesting entity 400 using a suitable communication network and method. In step 420, the data requesting entity 400 may receive the forecasted market spending for the specified demographic market sector.

Exemplary Method for Generation of Demographic Market Sectors with Associated Spending Data

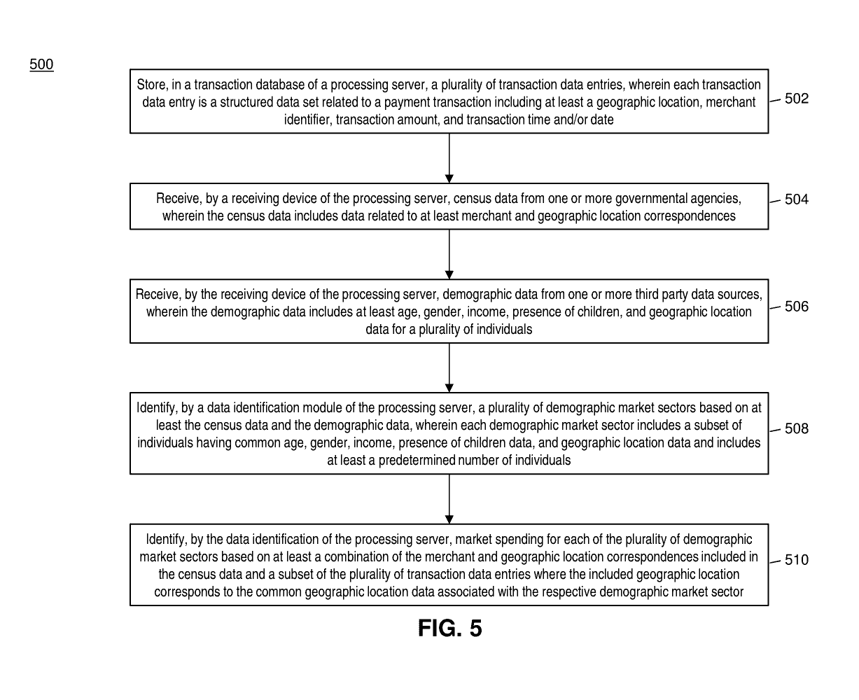

FIG. 5 illustrates a method 500 for the generation of demographic market sectors based on census and demographic data and market spending data associated therewith.

In step 502, a plurality of transaction data entries (e.g., transaction data entries 208) may be stored in a transaction database (e.g., the transaction database 206) of a processing server (e.g., the processing server 102), wherein each transaction data entry is a structured data set related to a payment transaction including at least a geographic location, merchant identifier, transaction amount, and transaction time and/or date. In step 504, census data may be received from one or more governmental agencies (e.g., governmental agencies 104) or the like by a receiving device (e.g., the receiving device 202) of the processing server, wherein the census data includes data related to at least merchant and geographic location correspondences. In step 506, the receiving device of the processing server may receive demographic data from one or more third party data sources (e.g., demographic tracking agencies 108), wherein the demographic data includes at least age, gender, income, presence of children, and geographic location data for a plurality of individuals.

In step 508, a plurality of demographic market sectors may be identified by a data identification module (e.g., the data identification module 216) of the processing server based on at least the census data and the demographic data, wherein each demographic market sector includes a subset of individuals having common age, gender, income, presence of children data, and geographic location data and includes at least a predetermined number of individuals. In step 510, market spending may be identified for each of the plurality of demographic market sectors by the data identification module of the processing server based on at least a combination of the merchant and geographic location correspondences included in the census data and a subset of the plurality of transaction data entries where the included geographic location corresponds to the common geographic location data associated with the respective demographic market sector.

In one embodiment, the demographic data may not include personally identifiable information for any of the plurality of individuals. In some embodiments, the census data may further includes economic market data and the method 500 may also include redistributing, by the data identification module of the processing server, the market spending for each of the plurality of demographic market sectors based on at least the economic market data and a mean market spending for a subset of demographic market sectors that includes the respective demographic market sector and additional demographic market sectors where the included subset of individuals have common geographic location data. In a further embodiment, the economic market data may include correspondences between market spending and demographics. In another further embodiment, the economic market data may include correspondences between market spending and geographic location.

In one embodiment, the method 500 may further include dividing, by the data identification module of the processing server, the market spending for at least one demographic market sector into a time series, wherein the time series includes a plurality of periods of time and the market spending for each entry of the time series is based on at least the transaction amount included in each transaction data entry where the included geographic location corresponds to the common geographic location data associated with the respective demographic market sector and where the included transaction time and/or date is included in the respective period of time. In a further embodiment, the method 500 may even further include forecasting, by a modeling module (e.g., the modeling module 218) of the processing server, market spending for a future period of time for the at least one demographic market sector based on at least the market spending for one or more entries in the time series. In an even further embodiment, the method 500 may also include: receiving, by the receiving device of the processing server, a forecasting request from a computing system (e.g., the data requesting entity 400), wherein the forecasting request indicates the at least one demographic market sector and future period of time; and electronically transmitting, by a transmitting device (e.g., the transmitting device 222) of the processing server, the forecasted market spending for the future period of time to the computing system. In another further embodiment, the market spending may be forecasted using a seasonal time series model. In an even further embodiment, the seasonal time series model may be the Holt-Winters model.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods discussed herein, such as the methods illustrated in FIGS. 4 and 5, discussed above.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods discussed herein, such as the methods illustrated in FIGS. 4 and 5, discussed above. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for the generation of demographic market sectors with associated spending data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for the generation of demographic market sectors with associated spending data, comprising:
storing, in a transaction database of a processing server, a plurality of transaction data entries, wherein each transaction data entry is a structured data set related to a payment transaction including at least a geographic location, merchant identifier, transaction amount, and transaction time and/or date;
receiving, by a receiving device of the processing server, census data from one or more governmental agencies, wherein the census data includes data related to at least merchant and geographic location correspondences;
receiving, by the receiving device of the processing server, demographic data from one or more third party data sources, wherein the demographic data includes at least age, gender, income, presence of children, and geographic location data for a plurality of individuals;
identifying, by a data identification module of the processing server, a plurality of demographic market sectors based on at least the census data and the demographic data, wherein each demographic market sector includes a subset of individuals having common age, gender, income, presence of children data, and geographic location data and includes at least a predetermined number of individuals; and
identifying, by the data identification of the processing server, market spending for each of the plurality of demographic market sectors based on at least a combination of the merchant and geographic location correspondences included in the census data and a subset of the plurality of transaction data entries where the included geographic location corresponds to the common geographic location data associated with the respective demographic market sector.

2. The method of claim 1, wherein the demographic data does not include personally identifiable information for any of the plurality of individuals.

3. The method of claim 1, further comprising:
dividing, by the data identification module of the processing server, the market spending for at least one demographic market sector into a time series, wherein the time series includes a plurality of periods of time and the market spending for each entry of the time series is based on at least the transaction amount included in each transaction data entry where the included geographic location corresponds to the common geographic location data associated with the respective demographic market sector and where the included transaction time and/or date is included in the respective period of time.

4. The method of claim 3, further comprising:
forecasting, by a modeling module of the processing server, market spending for a future period of time for the at least one demographic market sector based on at least the market spending for one or more entries in the time series.

5. The method of claim 4, further comprising:
receiving, by the receiving device of the processing server, a forecasting request from a computing system, wherein the forecasting request indicates the at least one demographic market sector and future period of time; and
electronically transmitting, by a transmitting device of the processing server, the forecasted market spending for the future period of time to the computing system.

6. The method of claim 4, wherein the market spending is forecasted using a seasonal time series model.

7. The method of claim 6, wherein the seasonal time series model is the Holt-Winters model.

8. The method of claim 1, wherein
the census data further includes economic market data, and
the method further comprises:
redistributing, by the data identification module of the processing server, the market spending for each of the plurality of demographic market sectors based on at least the economic market data and a mean market spending for a subset of demographic market sectors that includes the respective demographic market sector and additional demographic market sectors where the included subset of individuals have common geographic location data.

9. The method of claim 8, wherein the economic market data includes correspondences between market spending and demographics.

10. The method of claim 8, wherein the economic market data includes correspondences between market spending and geographic location.

11. A system for the generation of demographic market sectors with associated spending data, comprising:
a transaction database of a processing server configured to store a plurality of transaction data entries, wherein each transaction data entry is a structured data set related to a payment transaction including at least a geographic location, merchant identifier, transaction amount, and transaction time and/or date;
a receiving device of the processing server configured to receive
census data from one or more governmental agencies, wherein the census data includes data related to at least merchant and geographic location correspondences, and
demographic data from one or more third party data sources, wherein the demographic data includes at least age, gender, income, presence of children, and geographic location data for a plurality of individuals; and
a data identification module of the processing server configured to
identify a plurality of demographic market sectors based on at least the census data and the demographic data, wherein each demographic market sector includes a subset of individuals having common age, gender, income, presence of children data, and geographic location data and includes at least a predetermined number of individuals, and
identify market spending for each of the plurality of demographic market sectors based on at least a combination of the merchant and geographic location correspondences included in the census data and a subset of the plurality of transaction data entries where the included geographic location corresponds to the common geographic location data associated with the respective demographic market sector.

12. The system of claim 11, wherein the demographic data does not include personally identifiable information for any of the plurality of individuals.

13. The system of claim 11, wherein the data identification module of the processing server is further configured to divide the market spending for at least one demographic market sector into a time series, wherein the time series includes a plurality of periods of time and the market spending for each entry of the time series is based on at least the transaction amount included in each transaction data entry where the included geographic location corresponds to the common geographic location data associated with the respective demographic market sector and where the included transaction time and/or date is included in the respective period of time.

14. The system of claim 13, further comprising:
a modeling module of the processing server configured to forecast market spending for a future period of time for the at least one demographic market sector based on at least the market spending for one or more entries in the time series.

15. The system of claim 14, further comprising:
a transmitting device of the processing server, wherein
the receiving device of the processing server is further configured to receive a forecasting request from a computing system, wherein the forecasting request indicates the at least one demographic market sector and future period of time, and
the transmitting device of the processing server is configured to electronically transmit the forecasted market spending for the future period of time to the computing system.

16. The system of claim 14, wherein the market spending is forecasted using a seasonal time series model.

17. The system of claim 16, wherein the seasonal time series model is the Holt-Winters model.

18. The system of claim 11, wherein
the census data further includes economic market data, and
the data identification module of the processing server is further configured to redistribute the market spending for each of the plurality of demographic market sectors based on at least the economic market data and a mean market spending for a subset of demographic market sectors that includes the respective demographic market sector and additional demographic market sectors where the included subset of individuals have common geographic location data.

19. The system of claim 18, wherein the economic market data includes correspondences between market spending and demographics.

20. The system of claim 18, wherein the economic market data includes correspondences between market spending and geographic location.
